(19) United States
(12) Patent Application Publication
(10) Pub. No.: US 2013/0192631 A1
(43) Pub. Date: Aug. 1, 2013

(54) TRASH CONTAINER

(71) Applicant: Donald Scoralle, Fountain Valley, CA (US)

(72) Inventor: Donald Scoralle, Fountain Valley, CA (US)

(21) Appl. No.: 13/358,634

(22) Filed: Jan. 26, 2012

(51) Int. Cl. B08B 1/00; B65D 25/00

(52) U.S. Cl. 134/6; 220/23.83

(57) ABSTRACT

The improved trash container may have a dustpan attached to the opening of the trash container. The dustpan engages the ground when the trash container is laid down flat. As the trash container is moved from one location to another, the lip of the dustpan is self sharpening. The ground sharpens the lip of the dust pan to further improve contact between the floor and the lip or mitigate dust from slipping under the dustpan itself when the waste product is being swept into the trash container. Moreover, the improved trash container may have a raised lower portion to balance the trashcan on the lip and the raised portion to facilitate contact between the lip and the ground. The lip may be manufactured from a softer material compared to the raised proportion to increase the life span of the improved trash container.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The embodiments disclosed herein relate to a trash container. In a garage, leaves, paper products and waste products may be strewn about the ground. To pick up the waste product, the resident may sweep up the waste product in a dustpan and transfer the waste product from the dustpan to a trashcan. Unfortunately, the dustpan and the sweeper are separate items and may be misplaced. When dust pans are not available, the user may lay a piece of paper on the ground and sweep the waste product on the piece of paper and transfer the waste product from the paper to the trashcan. Unfortunately, this is a less than efficient work around when a dust pan is not available. Alternatively, the resident may lay a trash bag on the ground while holding the edge of the periphery of the trash bag on the ground in an attempt to sweep the waste product directly into the trash bag. Unfortunately, to spread the edge of the trash bag taut against the ground and sweep the waste product into the trash bag requires two people.

Accordingly, there is a need in the art for an improved method and device for collecting waste product on the ground.

### BRIEF SUMMARY

The embodiments disclosed herein address the needs discussed above, discussed below and those that are known in the art. The improved trash container incorporates a dustpan attached to an opening of the trash container so that the trash container can be used in the erected position as well as in the laid down position for sweeping waste product on the ground into the trash container with a broom or other similar device. Moreover, the side panel of the trash container with the dust pan attached thereto may have a raised portion which lifts the bottom side of the trash container off of the ground when the trash container is in the laid down position or sweeping position. The raised portion balances the trash container on the raised portion and a lip or edge of the dustpan to facilitate or encourage the entire length of the lip to contact the ground. If the trash container is warped, the warpage does not affect how the lip of the trash container contacts the ground since the trash container is balanced on the edge of the lip and the raised portion. Additionally, the first side panel may be angled downward when the trash container is in the sweeping position to urge waste product to the bottom side of the trash container after being swept over the dustpan and into the trash container. Additionally, the lip of the dustpan may be fabricated from a material that can be ground down as the trash container is being dragged on the floor in the sweeping position to pick up waste product distributed on the ground. The raised portion may have a durable material that is more durable and resistant to wearing than the lip. The trash container can outlast or be more durable than the dustpan or lip. The lip may be replaceable. It is also contemplated that the dustpan may have reinforced sides as well as be removably attachable to a body of the trash container.

More particularly, a trash container for sweeping waste product on a ground into the container is disclosed. The trash container may comprise a body and a dust pan. The body may have a plurality of side panels and a bottom panel which collectively hold the waste product when the trash container is oriented in an upright position. The dust pan may be attached to a first flat side panel of the plurality of side panels. An edge of the dust pan may have a ground interface surface and a dusting surface which collectively form a lip. The ground interface surface may be flush with a ground when the trash container is oriented in a sweeping position. Friction between the ground interface surface and the ground may sharpen the lip as the trash container is moved on the ground when sweeping different areas of the ground.

The dust pan may extend outside a periphery of an opening of the container so that the first panel is sloped downward to hold the waste product in the trash container when the trash container is oriented in the sweeping position. The angle (i.e., downward slope) between the ground and the first panel when the trash container is oriented in the sweeping position may be about 2 degrees to about 25 degrees and preferably between 2 degrees and 8 degrees.

The first panel may have a raised portion at a lower portion of the first panel so that the lip remains flush to the ground by balancing the trash container on the lip and the raised portion when the trash container is oriented in the sweeping position. The raised portion may be centrally located on a width of the first panel.

The plurality of panels may comprise the first side panel and second, third and fourth side panels arranged to have a rectangular configuration.

The dust pan may be removable attachedable to upper edge portions of the plurality of side panels. The side portions of the dust pan may be reinforced. In particular, the reinforced side portions have a bent member.

The second side panel opposite the first side panel may have a handle.

Additionally, a method of sweeping up waste product from a ground is disclosed. The method may comprise the steps of laying down a trash container on the ground in a sweeping position; balancing the trash container on a wide lip and a raised nub portion on a first side panel of the trash container; sweeping waste product onto the wide lip and into the trash container; moving the trash container to different areas on the ground to sweep up waste product; sharpening the lip during the moving step; and erecting the trash container in an upright position.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an improved trash container in an erect position;

FIG. 2 is a perspective view of the improved trash container shown in FIG. 1 in a sweeping position;

FIG. 3 is a side view of the improved trash container shown in FIG. 2;

FIG. 4 is a rear perspective view of the improved trash container shown in FIG. 1;

FIG. 5 is an enlarged view of a lip of a dust pan shown in FIG. 3;

FIG. 6 illustrates a second embodiment of the improved trash container with a removably attachable dust pan tray body of the trash container;

FIG. 7 is a side view of an improved trash container in an erect position with a lid;

FIG. 8 is a perspective view of the improved trash container shown in FIG. 7 in a sweeping position;

FIG. 9 is a side view of the improved trash container shown in FIG. 8;

FIG. 10 is a second embodiment of a lid of the improved trash container;

FIG. 11 is a cross sectional exploded view of the lid and the improved trash container; and

FIG. 12 is an exploded side view of a second embodiment of the pivoting connection between the lid and the improved trash container.

### DETAILED DESCRIPTION

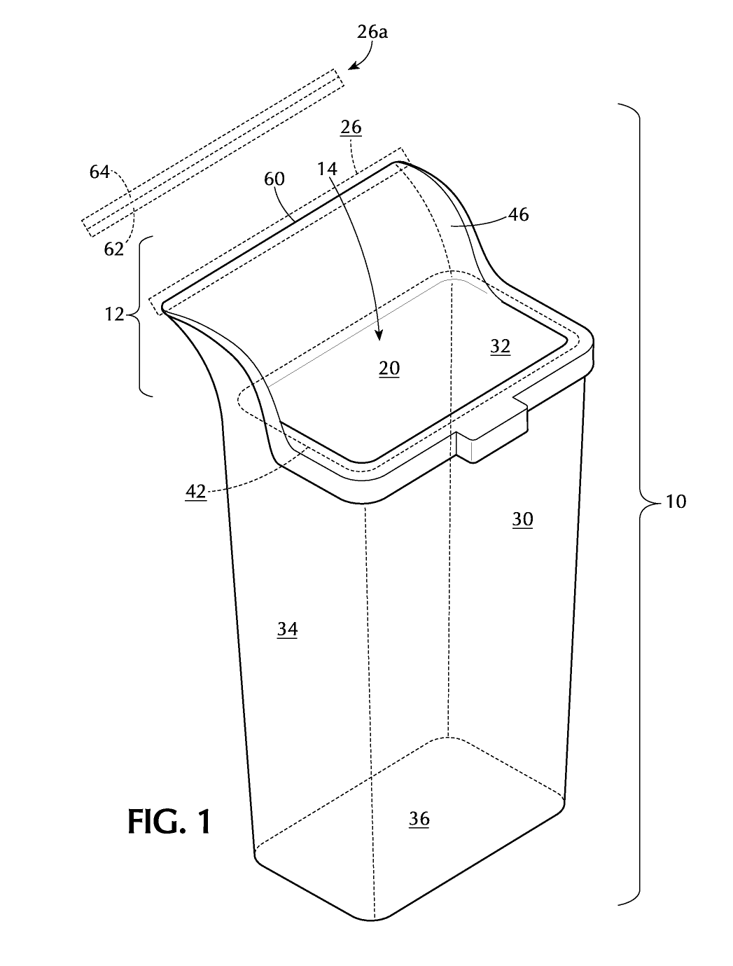

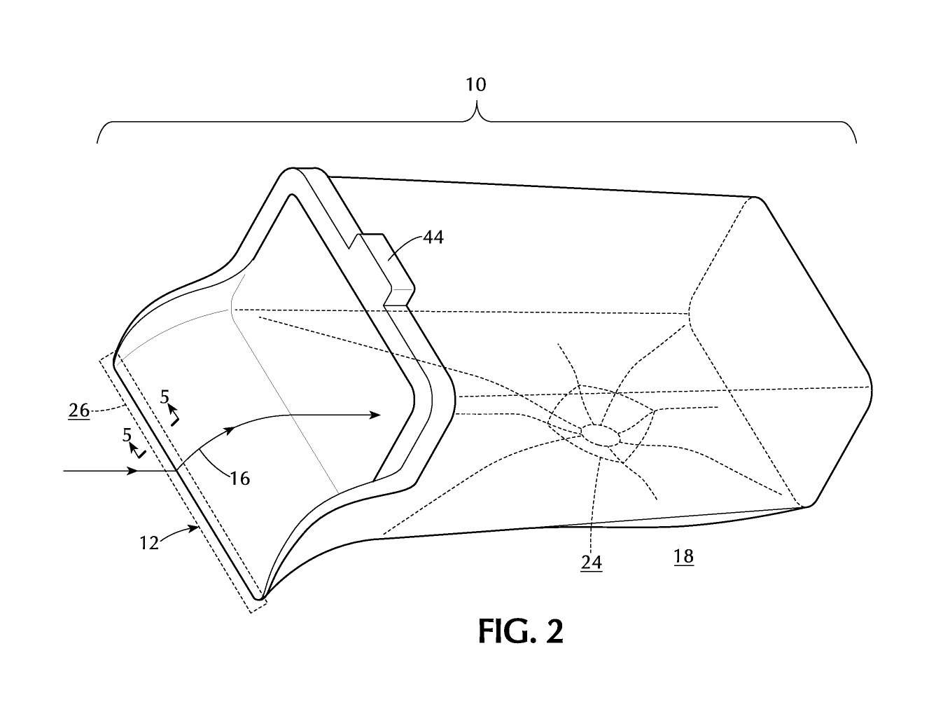

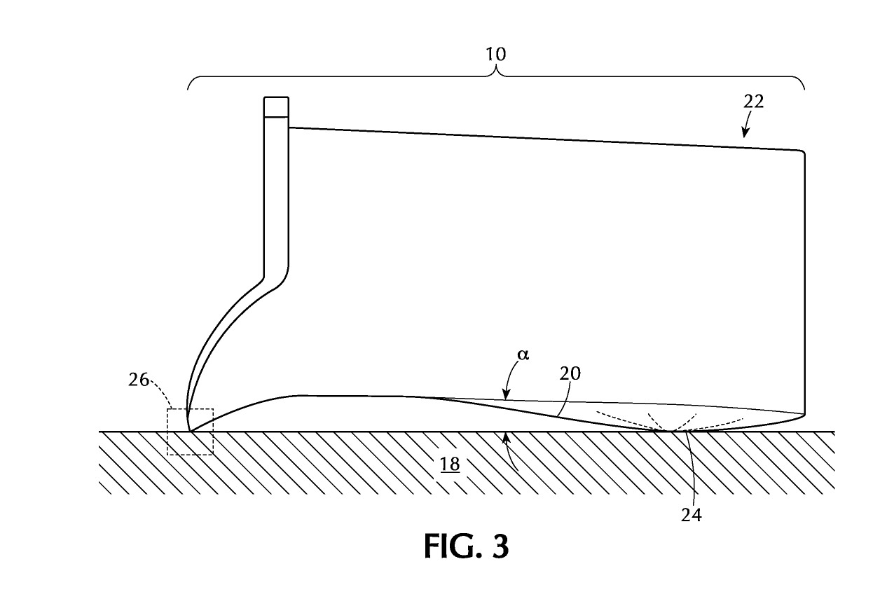

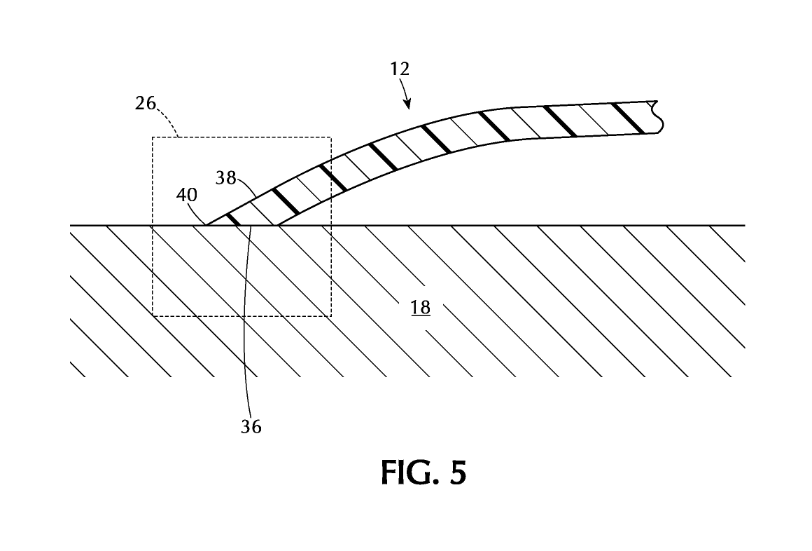

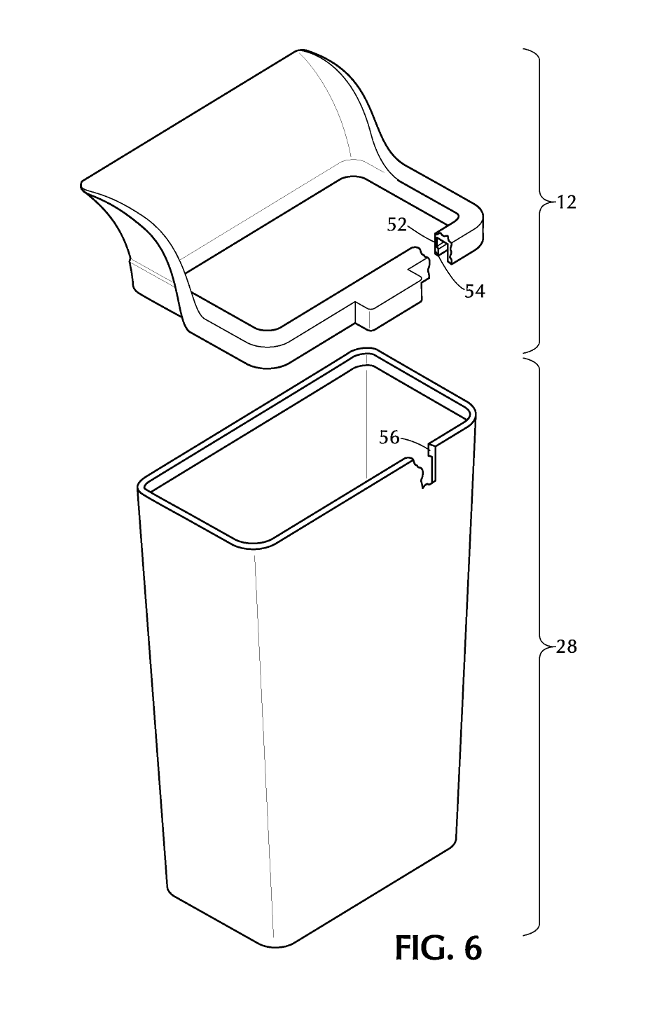

Referring now to the drawings, a trash container 10 is shown. The trash container 10 has a dust pan 12 attached to the opening 14 of the trash container 10. The trash container 10 may be used normally in the upright position as shown in FIG. 1. Also, the trash container 10 may be laid down, as shown in FIG. 2, so that the user can sweep waste product into the trash container 10 by way of the dust pan 12 as shown by arrow 16. When the trash container 10 is laid on the ground 18, a first side panel is angled downward (see angle a in FIG. 3) so that waste product is urged to the bottom side 22 of the trash container 10 after being swept over the dust pan 12. The first side panel 20 has a raised portion 24 at the bottom side 22 of the trash container 10, as shown in FIGS. 2-4. When the trash container 10 is laid on the ground, as shown in FIGS. 2 and 3, the trash container 10 is balanced on a lip 26 and the raised portion 24. Referring now to FIG. 5, the lip 26 is self sharpening and provides a better fit to the ground 18 over a period of time as the trash container 10 is moved from location to location sweeping up waste product. As the user pushes the trash container 10 on the ground to pick up waste, over a period of time, the lip 26 conforms to the shape of the ground 18. Referring now to FIG. 6, the dust pan 12 may optionally be removably attachable to the body 28 of the trash container 10.

Referring back to FIG. 1, the trash container 10 may have the first side panel 20, opposed second side panel 30, third side panel 32 and fourth side panel 34. The side panels 20, 30, 32, 34 may be collectively joined together to form a rectangular shaped trash container 10. The rectangular configuration allows the trash container 10 to fit into a narrow square space such as between shelving, boxes, etc. Although the trash container 10 is shown as having a rectangular configuration (preferred due to space saving), other configurations are also contemplated such as circular, octagonal, triangular, etc. The bottom ends of the first, second, third and fourth side panels 20, 30, 32, 34 may be joined to each other by way of a bottom panel 36. The bottom panel 36 may be flat so that the trash container 10 may be traversed to the erected position (see FIG. 1). The side panels 20, 30, 32, 34 and the bottom panel 36 hold the waste product in the trash container 10. Normally, the trash container 10 may be oriented in the upright position as shown in FIG. 1. Users may throw trash into the trash container 10 through the opening 14.

For waste product that is distributed on the ground which is inconvenient to pick up individually by hand, the trash container 10 may be laid down on the ground as shown in FIG. 2. This is identified as the sweeping position. In the sweeping position, the lip 26 of the dust pan 12 contacts the ground 18. The user may sweep waste product into the trash container with a broom or other similar device.

The lip 26 mates flush with the ground by balancing the lip 26 of the trash container 10 on the ground 18. In particular, the bottom side of the trash container 10 has the raised portion 24, as shown in FIGS. 2-4. The raised portion 24 may be formed on the first side panel 20. Preferably, the raised portion 24 is a single bump or nub on the first side panel 20. When the trash container 10 laid down in the sweeping position, the raised portion 24 contacts the ground. The raised portion lifts the bottom side of the trash container up as shown in FIG. 3. The trash container 10 falls down and the lip 26 contacts the ground. The trash container 10 is balanced on the lip 26 and the raised portion 24. Since the raised portion 24 is only a single location, any warpage of the trash container 10 at the bottom side 22 of the trash container does not affect the contact between the lip 26 and the ground 18. The entire length of the lip 26 remains flush with the ground 18.

As the trash container 10 (see FIG. 2) is moved from location to location to sweep up waste product on the ground, the lip 26 maintains constant contact with the ground 18, as shown in FIG. 5. Additionally, since the ground is typically course, the lip 26 is being constantly sharpened as the trash container 10 is dragged on the ground 18. If the entire length of the lip 26 is not initially flush with the ground 18, then the lip 26 over a period of time will eventually be ground down so that the lip 26 conforms to the surface of the ground 18. The lip 26 of the dust pan 12 may be fabricated from a material that can be ground down by the ground 18. By way of the example and not limitation, the lip 26 may be fabricated from a polycarbonate material, polyurethane material, plastic material, synthetic rubber, natural rubber, or the like. If the lip 26 is fabricated from a polyurethane material then preferably the hardness of the material is about or less than Shore A 75 to allow for quick grinding and conformity of the lip 26 to the ground. The material selected for the lip 26 should allow the lip 26 to be ground down through repeated movement of the trash container 10 while in the sweeping position. In contrast to the lip 26, the raised portion 24 may be fabricated from a more durable material. By way of example, an exterior surface of the raised portion 24 may be coated with or covered with a scuff resistant padding. The scuff resistant padding may be manufactured from material such as steel reinforced rubber, steel, aluminum, and the like. Accordingly, the raised portion 24 or a padding thereon may be manufactured from a material more durable than the lip 26. Alternatively, the raised portion 24 may be thicker compared to the average thickness of the first side panel 20 so that the raised portion 24 is more durable.

Referring now to FIG. 5, the lip 26 may define a ground interface surface 36 and a dusting surface 38 which intersects with each other at edge 40 of the lip 26. The dust pan 12 is attached to the body 28 of the trash container 10 in an orientation so that the ground interface surface 36 is flush with the ground 18 when the trash container 10 is in the sweeping position. Generally, the dust pan 12 may be attached to the body 28 so that edge 40 maintains contact with the ground 18 so that waste product (e.g., dust, paper, etc.) does not slip under the dust pan 12 when the waste product is being swept into the trash container 10 by way of the dust panel 12. As the user moves the trash container 10 on the ground 18, the ground 18 being course grinds down the ground interface surface 36. Over a period of time, the ground interface surface 36 matches the contour of the ground 18. If the trash container 10 is warped through heat and the lip 26 does not lay flush to the ground, the ground interface surface 36 will eventually be ground down so that the lip 26 will eventually conform to the ground 18.

Referring back to FIG. 1, the dust pan 12 preferably extends outward from an outer periphery 42 of the opening 14 of the trash container 10. In this manner, when the trash container 10 is laid down in the sweeping position (see FIG. 3), the first panel 20 slopes downward at an angle a. This urges waste product down to the bottom side 22 of the trash container 10 once the waste product enters the trash container 10. After sweeping up the waste product, the user may grasp handle 44 to pick up the trash container 10 and traverse the trash container 10 from the sweeping position to the upright position.

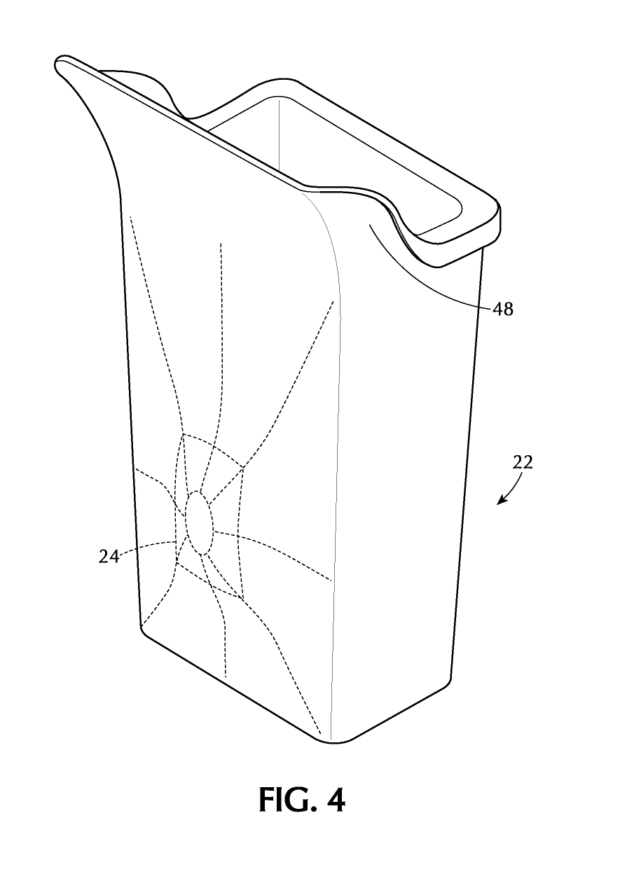

Referring now to FIGS. 1 and 4, the dust pan 12 may additionally have side walls 46, 48. These side walls 46, 48 redirect waste product into the trash can that would have been swept to the side of the dust pan 12. Moreover, the sidewalls 46, 48 may be reinforced by having a bend.

Referring now to FIG. 6, the dust pan 12 may be removably attachable to a body 28 of the trash container 10. The dust pan 12 may have an inner lip 52. The inner lip extends downward and also has an edge 54. The body 28 of the trash container 10 may have a bead 56 which is caught by the lip 52 and the edge 54 to hold the dust pan 12 on the body 28. A trash liner may be placed in the body 28. The upper edge portion of the trash liner is wrapped over the edge of the body 28. The dust pan 12 can then be mounted to the body to secure the trash liner in the trash container 10.

The body 28 and the dust pan 12 may be a unitary structure as shown in FIGS. 1-4. By way of example, the body 28 and the dust pan 12 may be fabricated as a single blow molded piece. Alternatively, the body 28 and the dust pan 12 may be permanently attached to each other through adhesive, sonic welding, etc. Moreover, the body and the dust pan 12 may be fabricated as two separate components as described in relation to FIG. 6.

Optionally, the lip 26a may be removably mountable to the dust pan 12 as shown in FIG. 1. The lip 26a may be mounted to an edge 60 of the dust pan through rivets, adhesive, chemical bonding, hooks and loops and the like. The lip 26a may be rigid as in the embodiments discussed above. Alternatively, the lip 26a may have a rigid member 62 and a flexible member 64. The rigid member 62 may be attached to the edge 60 as discussed. The flexible member 62 may form a seal with the ground so that waste product does not slip under the lip 26a and the dust pan 12 as waste product is being swept into the trash container 10.

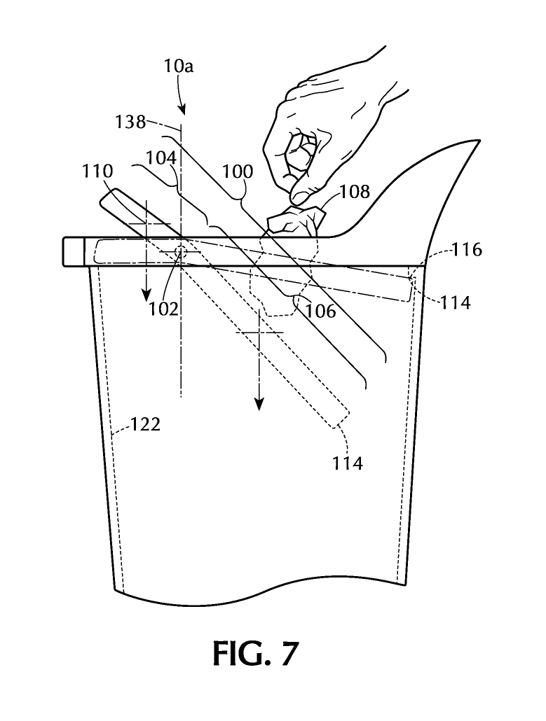

Referring now to FIG. 7, the trash container 10a may be fitted with a lid 100. The lid 100 may rotate about pivot point 102 which defines a first portion 104 and a second portion 106 of the lid 100. When the trash container 10a is in the upright position, as shown in FIG. 7, trash 108 may be thrown into the trash container 10a by pivoting the second portion 106 about the pivot point 102 in the down direction shown in FIG. 7. After the trash 108 is secured in the trash container 10a, the first portion 104 which may be heavier than the second portion 106 may rotate the lid 100 back to its closed position as shown by the dash lines in FIG. 7. More particularly, the moment caused by the weight of the first portion 104 about the pivot point 102 may be greater than the moment caused by the weight of the second portion 106 about the pivot point 102. Hence, after trash 108 is inserted into the trash container 10a, the lid 100 pivots back up to the closed position. Moreover, the distal end 114 may contact the edge 116 of the improved trash container 10a to keep the lid 100 in the level position or the closed position.

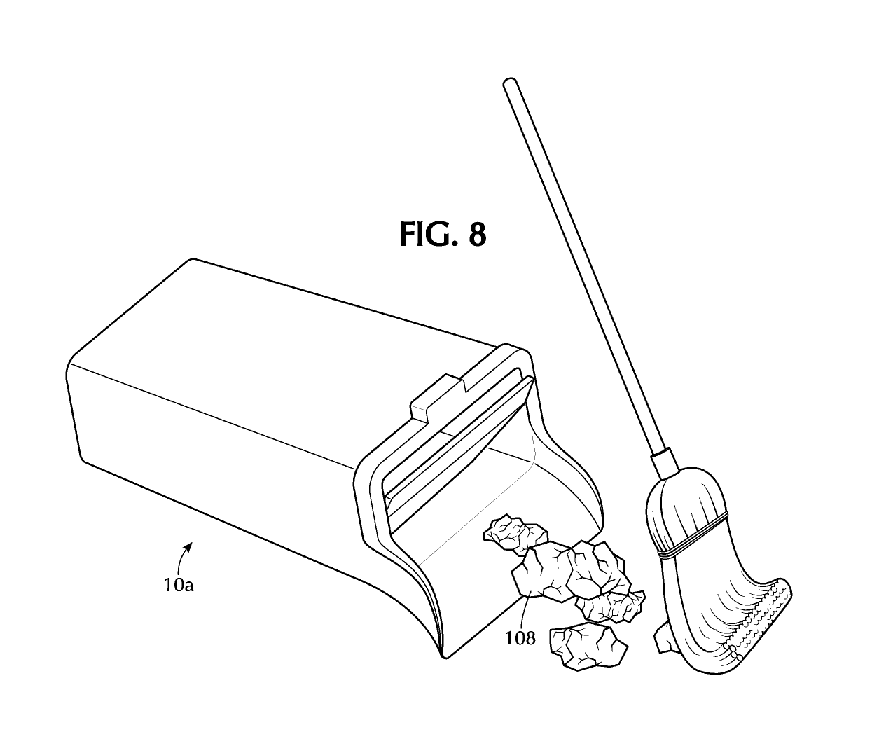

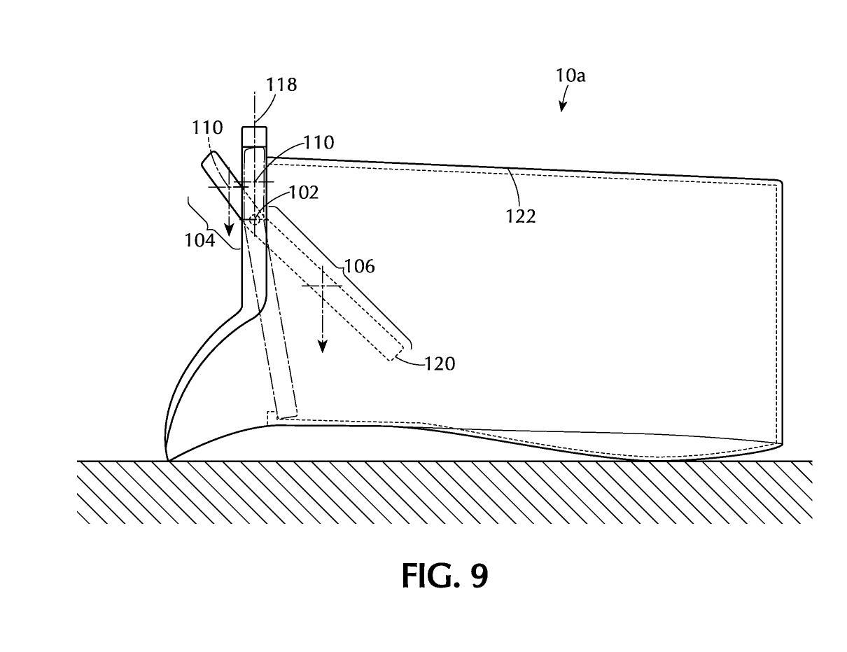

Beneficially, as shown in FIG. 8, the trash container 10a may also be laid down on the ground 18 in the sweeping position. When trash 108 is swept into the trash container 10a, the lid 100 rotates about the pivot point 102 to allow insertion of the trash 108 into the trash container 10a. The weight of the first portion 104 rotates the lid 100 to the opened position. Referring to FIG. 9, the moment caused by the weight of the first portion 104 about the pivot point 102 is greater than the moment caused by the weight of the second portion 106 about the pivot point 102. To increase the moment caused by the weight of the first portion 104, the first portion 104 may be embedded with heavy materials. By way of example and not limitation, the lid 100 may be fabricated from a plastic, lightweight material whereas the first portion 104 of the lid 100 may have metallic plates embedded therein or attached thereto. When the center of gravity 110 of the first portion 104 goes over the vertical center line 118 of the pivot point 102 as the trash 108 is pushed into the container, the weight of the first portion 104 causes a moment about the pivot point 102 greater than the moment of the weight of the second portion 106 about the same pivot point 102. This causes the lid to rotate counterclockwise until a distal end 120 of the second portion 106 of the lid 100 contacts the interior surface 122 of the trash container 10a. In the embodiment shown in FIG. 9, the center of gravity 110 of the first portion 104 does not initially cause the lid 100 to rotate in the counterclockwise direction. Only after the trash 108 pushes the second portion 106 slightly inward does the center of gravity 110 of the first portion 104 cross the vertical center line 118 of the pivot point 102. When the weight of the first portion 104 creates a moment about pivot point 102 greater than the moment caused by the second portion 106, the lid 100 is rotated until the distal end 120 contacts the interior surface 122 of the improved trash container 10a.

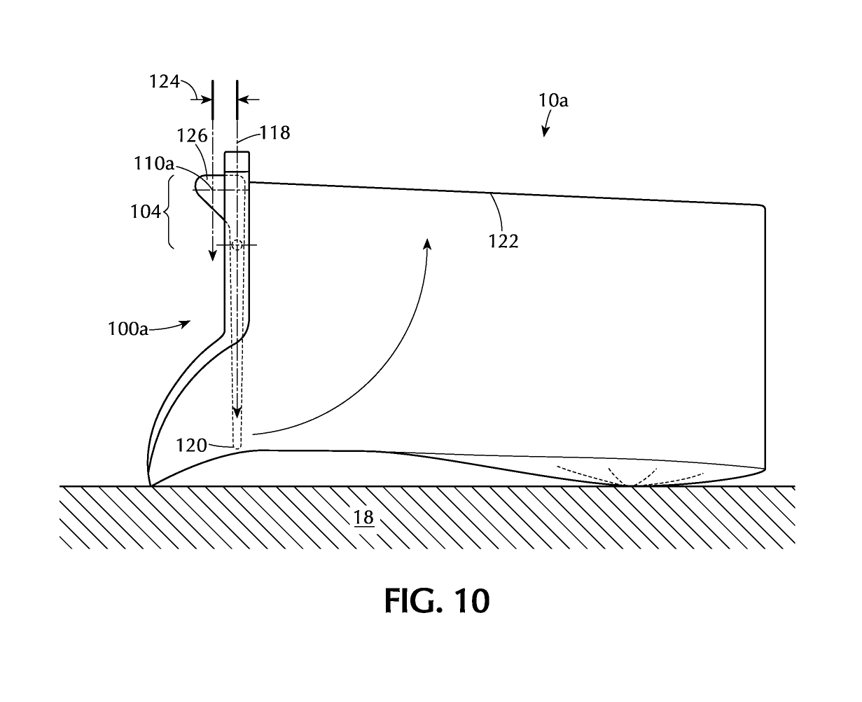

Referring now to FIG. 10, the first portion 104 may be designed so that the center of gravity 110a is over the vertical center line 118 when once the trash container 10a is laid on the ground 18. The first portion 104 may have a built up area 126 that shifts the center of gravity 110a over the vertical center line 118. Once the improved trash container 10a is laid on the ground 18, the weight of the first portion 104 rotates the lid 100 until the distal end 120 contacts the interior surface 122 of the improved trash container 10a. In the embodiments shown in

FIGS. 9 and 10, when the improved trash container 10a is lifted back up in to the erect position, the lid 100 may pivot back to the closed position where the weight of the first portion 104 will maintain the lid 100 in the closed position.

Referring back to FIG. 7, the lid 100 may be designed so that the center of gravity 110 of the first portion 104 does not cross the vertical center line 138 of the pivot point 102 when trash 108 is being put into the trash container 10. By way of example and not limitation, the distal end 114 of the lid 100 may contact the interior surface 122 of the trash container 10a before the center of gravity 110 of the first portion 104 crosses the vertical centerline 138. In this manner, the lid 100 rotates back to the closed position when the trash container 10a is erected to the vertical position since the moment caused by the weight of the first portion 104 is greater than the moment caused by the weight of the second portion 106 about the pivot point 102. The user does not need to touch the lid 100 to close the trash container 10a.

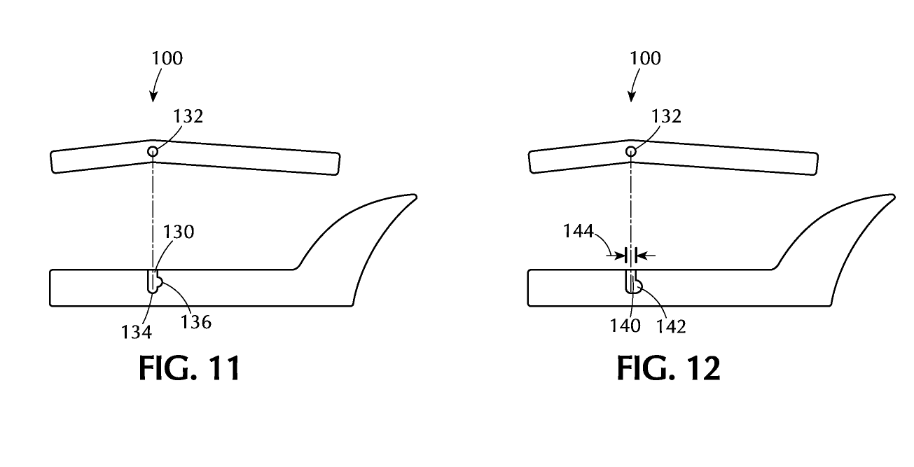

Referring now to FIG. 11, the lid 100 may be pivotally connected to the improved trash container 10a at cutout 130. Opposed sides of the trash container has cutouts 130. The lid 100 in FIG. 11 is shown as being the same embodiment shown in FIG. 9. However, the other lid 100a is also connectable to the trash container shown in FIGS. 11 and 12. The lids 100, 100a may have round pins 132 on opposed sides thereof that extends out of the lid 100, 100a. The pins 132 may be circular and have a diameter equal to a diameter of a first circular cutout 134. When the improved trash container 10a is in the erect position, the lid 100 pivots about or within the circular cutout 134. When the improved trash container 10a is laid on the ground 18 as shown in FIGS. 9 and 10, the pin 132 is received into a second circular cutout 136 which is pointed downwardly to prevent the lid 100 from detaching from the improved trash container 10a.

Referring now to FIG. 12, the improved trash container 10a may have a cutout 140 and a cavity 142. When the improved trash container 10a is in the sweeping position or laid down on the ground 18, the cavity 142 points downwardly so that the pins 132 of the lid 100 are seated within the cavity 142 and cannot or are less likely to be pulled out of the cutouts 140. The cutouts 140 have a width 144 which may be slightly less than, equal to, or slightly greater than a diameter of the pin 132. If the width 144 is slightly less than the diameter 142 of the pin 132, then the deformation of the material surrounding the cutout 140 allows the pin 132 to be snapped into the cutout 140 and into the cavity 142. In this manner, the lid 100 cannot be pulled out during use.

The above description is given by way of example, and not limitation. Given the above disclosure, one skilled in the art could devise variations that are within the scope and spirit of the invention disclosed herein, including various ways of attaching the lip 26a to the dust pan 12. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A trash container for sweeping waste product on a ground into the container, the trash container comprising:
a body having a plurality of side panels and a bottom panel which collectively hold the waste product when the trash container is oriented in an upright position;
a dust pan attached to a first flat side panel of the plurality of side panels, an edge of the dust pan having a ground interface surface and a dusting surface which collectively form a lip, the ground interface surface being flush with a ground when the trash container is oriented in a sweeping position;
wherein friction between the ground interface surface and the ground sharpens the lip as the trash container is moved on the ground when sweeping different areas of the ground.

2. The container of claim 1 wherein the dust pan extends outside a periphery of an opening of the container so that the first panel is sloped downward to hold the waste product in the trash container when the trash container is oriented in the sweeping position.

3. The container of claim 2 wherein the angle between the ground and the first panel when the trash container is oriented in the sweeping position is about 2 degrees to about 25 degrees.

4. The container of claim 2 wherein the first panel has a raised portion at a lower portion of the first panel so that the lip remains flush to the ground by balancing the trash container on the lip and the raised portion when the trash container is oriented in the sweeping position.

5. The container of claim 4 wherein the raised portion is centrally located on a width of the first panel.

6. The container of claim 1 wherein the plurality of panels comprises the first side panel and second, third and fourth side panels arranged to have a rectangular configuration.

7. The container of claim 1 wherein the dust pan is removable attachedable to upper edge portions of the plurality of side panels.

8. The container of claim 1 wherein the side portions of the dust pan are reinforced.

9. The container of claim 8 wherein the reinforced side portions have a bent member.

10. The container of claim 1 wherein a second side panel opposite the first side panel has a handle.

11. The container of claim 1 further comprising a lid rotateable between open and closed positions about a pivot point, the lid defining first and second portions wherein the second portion is closer to the dust pan than the first portion when the lid is in the closed position, the first portion being heavier than the second portion so that the weight of the first portion traverses the lid to the closed position when the container is disposed in the upright position and the weight of the first portion traverses the lid to the open position when the container is disposed in the sweeping position.

12. A method of sweeping up waste product from a ground, the method comprising the steps of:
laying down a trash container on the ground in a sweeping position;
balancing the trash container on a wide lip and a raised nub portion on a first side panel of the trash container;
sweeping waste product onto the wide lip and into the trash container;
moving the trash container to different areas on the ground to sweep up waste product;
sharpening the lip during the moving step;
erecting the trash container in an upright position.
